(19) United States
(12) Patent Application Publication
(10) Pub. No.: US 2010/0147090 A1
(43) Pub. Date: Jun. 17, 2010

(54) Device for Generating a Circular Oscillation or a Directional Oscillation Having Continuously Adjustable Oscillation Amplitude and/or Exciter Force

(75) Inventor: Hans-Werner Kuerten, Goedenroth (DE)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: BOMAG GMBH, Boppard (DE)

(21) Appl. No.: 12/574,465

(22) Filed: Oct. 6, 2009

(30) Foreign Application Priority Data
Oct. 6, 2008 (DE) 102008050576.5

(51) Int. Cl. B06B 1/16; E02D 3/074; E01C 19/38; F16H 33/20

(52) U.S. Cl. 74/61

(57) ABSTRACT

A device for generating a circular oscillation or a directional oscillation is provided. The device provides a circular oscillation, or, if two parallel main shafts rotating synchronously in opposite directions are coupled, a directional oscillation, each main shaft having unbalance weights and a coupling between the unbalance weights and the oscillation amplitude of the exciter force per main shaft being continuously adjustable between a minimum value and a maximum value using an adjustment unit via the relative rotation of the unbalance weights toward or away from one another. The device includes unbalance weights that are mounted on the main shaft so they are rotatable thereon, and the coupling comprises a transmission medium connected rotationally fixed to the main shaft, which is composed so that it acts as a driver on the unbalance weights and also causes a pivoting of the unbalance weights in opposite directions upon the adjustment of the oscillation amplitude of the exciter force.

### CROSS-REFERENCE TO RELATED APPLICATIONS

This application claims priority to foreign patent application DE 10 2008 050 576.5, filed on Oct. 6, 2008, the disclosure of which is incorporated herein by reference in its entirety.

### FIELD OF THE INVENTION

The present invention relates to a device for generating a circular oscillation or a directional oscillation.

### BACKGROUND OF THE INVENTION

Devices for generating circular or directional oscillation are used in particular in construction machines for soil compaction. Typically, two main shafts situated in parallel in the same housing are used, on each of which unbalance weights are located. To generate a directional oscillation, the main shafts are set into rotation synchronously and in opposite directions using directly meshing spur gears, for example. For the continuous adjustment of the oscillation amplitude of the exciter force, the angles of the unbalance weights are changed so that the effective exciter force, which is composed of the centrifugal forces of individual unbalance weights, increases or decreases continuously within a predetermined range.

Shafts are typically used for adjusting the oscillation amplitude and/or exciter force, on which unbalance weights are located, which are connected rotationally fixed to the shaft, on the one hand, and are mounted so they are rotatable thereon, on the other hand. To adjust the angle, the rotatably-mounted unbalance weights are adjusted and locked in their positions relative to the rotationally-fixed unbalance weights, typically only at a standstill.

An oscillation exciter having two unbalance bodies displaceable to one another is known from DE 2736264 A1, which also allows an adjustment during the operation. For this purpose, a first unbalance body in a forked part rotatable around a transverse axis is connected using a pushrod to a slide displaceable axially on the rotational axis to shift the unbalance body. A further unbalance body is positively connected to the first unbalance body using a gearing. If the slide is moved axially, the two unbalance bodies pivot either toward or away from one another. The amplitude of the exciter force is varied in this way. However, it is disadvantageous that for this purpose the axially displaceable slide and the pushrod connection occupy a large amount of space on the rotational axis, so that a compact construction of the oscillation exciter is impossible.

Furthermore, the disadvantage is that in the oscillation exciter according to DE 2736264 A1, no latitude is given in regard to the configuration of unbalance bodies, because only two unbalance bodies may always be situated per rotation shaft. For example, if one wants to situate two further unbalance bodies on the same rotational axis, a further slide having a further pushrod must be situated on the other front face of the shaft, whereby the installation space would be enlarged still further. Furthermore, the pushrod represents a sensitive part as the connection part to the adjustment element. In addition, because of the asymmetrical configuration of the pushrod and because of the shape of the unbalance bodies themselves, even with the unbalance bodies completely shifted, no “zero setting” of the exciter force is possible, so that the machine continuously generates an imbalance and thus a directional oscillation as long as the shaft rotates.

### SUMMARY OF THE INVENTION

Embodiments of the present invention advantageously overcome the disadvantages of the known prior art. In particular, embodiments of the present invention allow a very compact construction for a device for generating a circular oscillation or a directional oscillation, the oscillation amplitude of the exciter force being continuously adjustable reliably and comfortably between a minimal value, which can be zero, but does not have to be, and a maximum value. In addition, embodiments of the present invention offer a modular expansion of the main shaft with additional unbalance weights that is easy, cost-effective, and also compact.

The device, according to embodiments of the present invention, has unbalance weights which are mounted on the particular main shaft so they are rotatable thereon. In addition, it has a coupling, which comprises a transmission medium connected rotationally fixed to the main shaft. This transmission medium is composed so that, on the one hand, it acts as a driver on the unbalance weights and, on the other hand, it causes pivoting of the unbalance weights in opposite directions upon adjustment of the oscillation amplitude of the exciter force.

The transmission medium of the coupling according to the invention assumes essentially two functions. On the one hand, it is used as the driver for the unbalance weights, which are situated adjacent, so that these unbalance weights rotate synchronously and in the same direction with the main shaft in normal operation, i.e., when a fixed setting has been selected for the oscillation amplitude of the exciter force. In addition, the transmission medium causes pivoting in opposite directions of the adjacent unbalance weights in the event of desired change of the angles of the unbalance weights, in order to change the oscillation amplitude of the exciter force during the running of the device.

Inter alia, great advantages are achieved in regard to the compactness of the entire device, the robustness of the coupling, and simple and rapid adjustment capability. Furthermore, production costs may be reduced thanks to the use of simple and identical components. The device is preferably to be used for generating a circular oscillation using a shaft or a directional oscillation, i.e., using at least two main shafts rotating in opposite directions.

In an advantageous embodiment of the present invention, the coupling comprises a device having gearing parts, preferably having bevel gears, in particular having at least one pinion and two crown wheels, one unbalance weight having one crown wheel in each case and the transmission medium being the at least one pinion, which is engaged with the two crown wheels. Crown wheel/pinion pairs have proven to be particularly suitable for fulfilling the features characterized in the independent claims.

It is particularly expedient for the coupling to have multiple transmission media, each situated offset by a preferably equal angle. Two transmission media are preferably used for reasons of symmetrical force distribution. However, depending on the application, more than two transmission media may also be used.

The transmission media are preferably situated so they are rotatable on a transmission medium carrier and have a rotational axis which perpendicularly intersects the rotational axis of the main shaft. Through this condition, the functions of the transmission medium, namely the driver function and the function of the rotational direction reversal upon adjustment, are made easier. However, other embodiments are also possible.

The main shaft preferably has at least one transverse hole for receiving the transmission medium carrier. Using the transverse hole, the transmission medium carrier can be inserted through the main shaft and subsequently equipped from both sides with transmission media, in particular bevel gears, and further parts.

According to a preferred embodiment, means, in particular axial bearings, for absorbing centrifugal forces, which are generated by the transmission medium, are situated on the transmission medium carrier. Due to the compact embodiment of the transmission medium, lesser centrifugal forces are generated than in typical devices in any case. Nonetheless, small axial ball bearings suggest themselves for absorbing centrifugal forces, in order to increase the operational reliability and smooth running still further.

It has proven to be advantageous for the transmission medium carriers to be mounted floating on the transmission medium carrier. Slight movements of the transmission medium along the longitudinal axis of the transmission medium carrier are thus possible. The transmission medium carrier is thus protected from excessive strain as a result of bending torques and tensions.

A further aspect of the present invention is that only one of the unbalance weights is connected to an adjustment unit. It is thus possible to adjust all unbalance weights situated on the same main shaft exactly using the adjustment of a single weight.

A further preferred embodiment of the present invention provides that the main shaft has multiple unbalance weight pairs each having two unbalance weights and a coupling situated between these unbalance weights. All unbalance weights may have the same size and mass. In the event of equal mass of the unbalance weights, the support torques cancel out mutually over the transmission medium carrier. The required support and adjustment forces are thus very low. Depending on the application, arbitrarily many unbalance weight pairs may be situated on one main shaft.

In a particularly preferred embodiment, the unbalance weight pairs are connected in series in that adjacent unbalance weights of the unbalance weight pairs are each connected in phase to one another. In this context, in phase is understood to mean that the angles of these unbalance weights relative to the main shaft are equal. Therefore, the phase difference is understood as the difference of the angles of the unbalance weights to one another.

It is particularly advantageous if the main shaft has an even number of unbalance weight pairs, which are connected in series. For example, if two, four, or six unbalance weight pairs (i.e., four, six, or eight unbalance weights having corresponding couplings) are connected in series on one main shaft, operation of the device free of tilting torque is always ensured, because the angles of the unbalance weights on the left and right are symmetrical relative to the center of gravity of the main shaft.

The unbalance weights of the device according to the invention preferably have means for axial play reduction and reduction of the tooth flank play. These means may be spring elements, for example.

According to a further embodiment of the present invention, the adjustment units of the two parallel main shafts are operationally linked. Because the adjustment sleeves of the adjustment units are synchronized with one another via directly meshing spur gears, for example, and are connected so they are pivotable in opposite directions, for example, in hydraulic adjustment units, single-acting cylinders may also be used instead of double-acting cylinders for one shaft in each case.

The device preferably provides an oil pump for lubricating the gearings and the roller bearings. The oil level in the housing can be reduced by the efficient metering using a sprinkler pipe. The performance loss because of the splashing of the unbalance weights in the oil bath is thus reduced.

Furthermore, it is advantageous to implement the device as pivotable using a pivot drive located outside the housing. The effective angle of the device according to the invention can thus be adapted as needed.

In addition, the device may have means for detecting the current position of the unbalance weights, in particular sensors for detecting the relative phase difference of the unbalance weights to be adjusted. It is thus also possible to implement a frequency adjustment while maintaining a specific centrifugal force.

A great advantage of the invention is the high degree of compactness. The device may thus be installed without problems and with only little effort even in already existing mass-produced machines.

### BRIEF DESCRIPTION OF THE DRAWINGS

The invention is explained in greater detail hereafter on the basis of drawings. In the schematic figures:

FIG. 1 shows a perspective partial view of the device according to the invention having partially cutaway adjustment sleeve in the starting position;

FIG. 2 shows a perspective partial view like FIG. 1, but adjusted by an angle;

FIG. 3 shows a perspective partial view like FIG. 1, but adjusted by 180°;

FIG. 4 shows a longitudinal section through the device according to the invention;

FIG. 5 shows a longitudinal section like FIG. 4, but with the unbalance weights adjusted by 180°;

FIG. 6 shows a perspective overall view of the device according to the invention;

FIG. 7 shows a perspective view of a further embodiment variant of the invention;

FIG. 8 shows a perspective view like FIG. 8, but adjusted by −45°;

FIG. 9 shows a perspective view like FIG. 8, but adjusted by +45°;

FIG. 10 shows a perspective view of a further embodiment variant of the invention.

### DETAILED DESCRIPTION

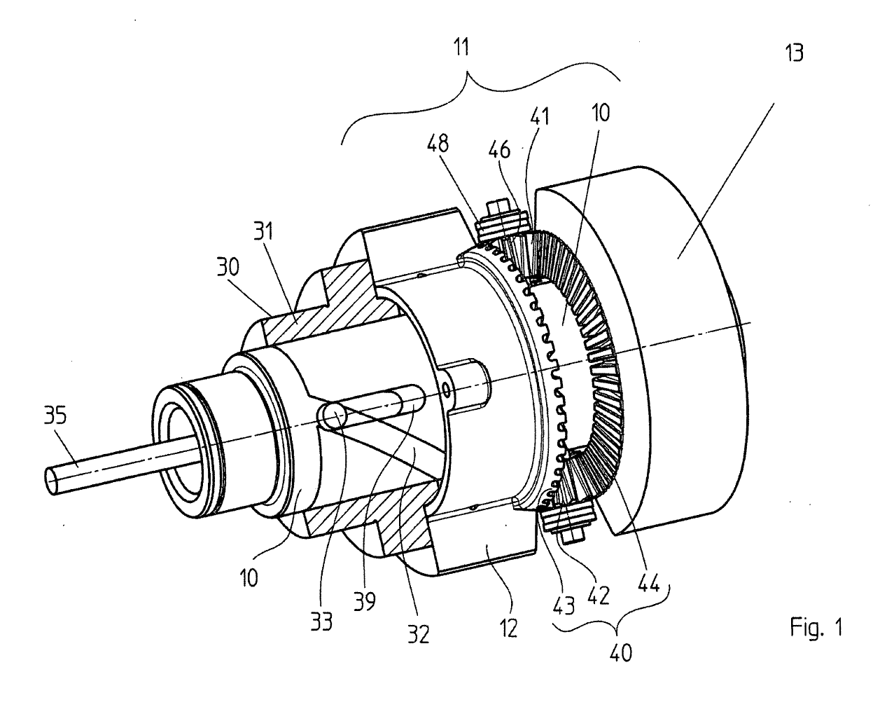

FIG. 1 shows a first unbalance weight pair 11 of the first main shaft 10 having the unbalance weights 12, 13. The coupling 40, which has the two crown wheels 43, 44 and the transmission medium 46, implemented as the pinions 41, 42, is located between the unbalance weights 12, 13. The pinions 41, 42 are situated symmetrically in relation to the rotational axis of the main shaft 10, offset by 180°, and so they are rotatable on the transmission medium carrier 45. Furthermore, axial bearings 48 are recognizable, which are used to absorb the centrifugal forces generated by the pinions 41, 42.

The adjustment unit 30 has an adjustment sleeve 31, which is connected rotationally fixed to the first unbalance weight 12 using an axial lock, e.g., via screws 36. The inner wall of the adjustment sleeve 31 is provided with two spiral grooves 32, which are situated offset by 180°. The adjustment pin 33, which is guided in an oblong hole 39 in the main shaft 10, engages in the spiral grooves 32. An axial movement of the adjustment piston 34, which is implemented in this exemplary embodiment using a single-acting hydraulic cylinder, thus results in a rotating movement of the adjustment sleeve 31 and thus of the unbalance weight 12. In the angles of the unbalance weights 12, 13 shown in FIG. 1, the unbalance weight 13 is pivoted by precisely 180° relative to the unbalance weight 12. Upon a rotation of the main shaft 10 in the position shown, the centrifugal force components of the unbalance weights cancel out mutually, so that no exciter force occurs.

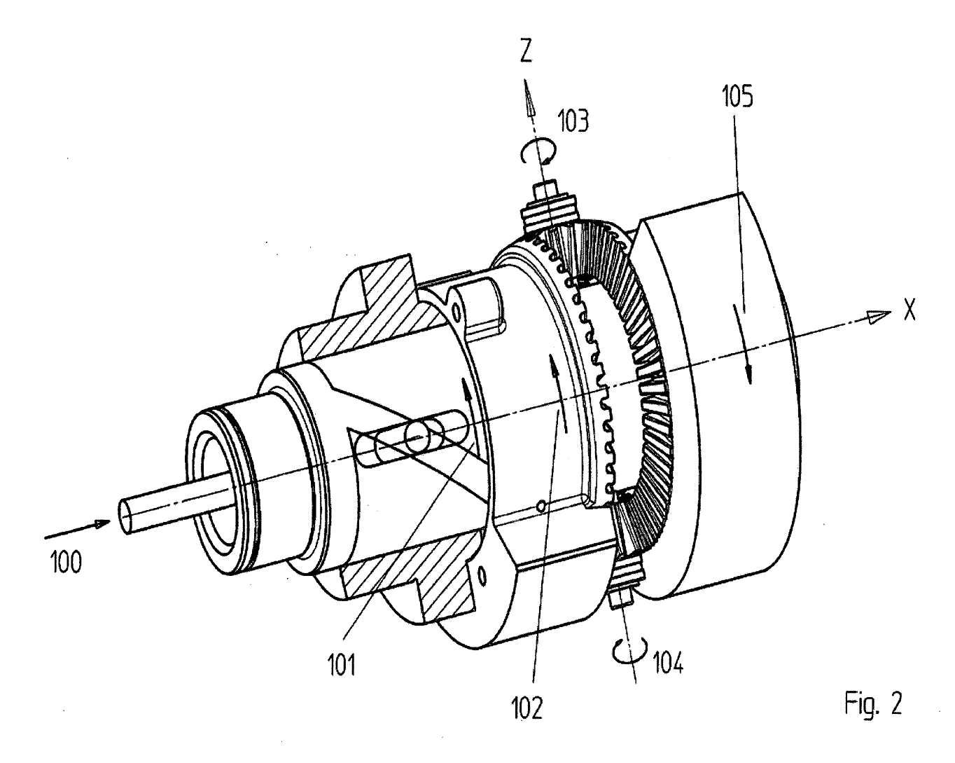

The adjustment according to the invention of the unbalance weights 12, 13 is described in greater detail on the basis of FIGS. 1, 2, and 3. For this purpose, firstly only the adjustment movement alone is described, i.e., in this case it is assumed for better understanding that the main shaft 10 is stationary. If pressure is exerted on the adjustment piston 34, the adjustment pin 33, which is connected to the adjustment piston 34, moves axially in the direction of the positive x axis, i.e., in the indicated arrow direction 100. The adjustment sleeve thus pivots together with the unbalance weight 12 connected thereto in the arrow directions 101 and 102, i.e., counterclockwise around the x axis, when this rotation is viewed from the tappet 35 in the direction of the positive x axis.

The crown wheel 43, which is connected fixedly to the unbalance weight 12, rotates like the unbalance weight 12 in the arrow direction 102. The pinions 41, 42, which are situated so they are rotatable on a transmission medium carrier 45 and are engaged with the crown wheel 43 via the bevel gearing, the transmission medium carrier 45 being connected rotationally fixed to the main shaft 10 in a transverse hole 49, are thus rotated. The rotation of the pinions 41, 42 occurs in the indicated arrow directions 103, 104, i.e., clockwise, when the rotation is observed from the axial bearings 48 of the pinion 42 in the direction of the positive z axis. The rotation of the pinions 41, 42 causes the pivoting of the crown wheel 44 and thus also of the unbalance weight 13. However, because of the implementation of the coupling 40 using bevel gears, i.e., using crown wheels 43, 44 and pinions 41, 42, the rotational direction of the unbalance weight 13 (arrow direction 105) is opposite to the rotational direction of the unbalance weight 12.

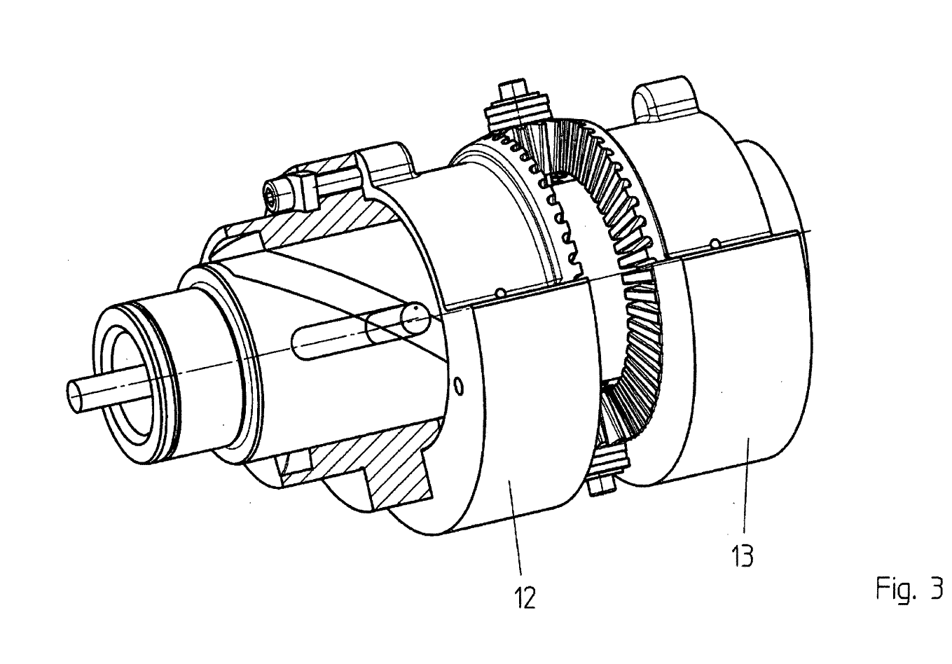

It has thus been shown that with the aid of the coupling 40, a very compact and simple adjustment of the angles of the unbalance weights 12, 13 is achieved. The pivoting of the unbalance weight 12 by 90° relative to its starting position in relation to the unbalance shaft 10, for example, also causes a pivot of the unbalance weight 13 by 90°, but in the opposite rotational direction, so that the unbalance weights 12, 13 pivot toward or away from one another by 180° relative to one another. The spiral grooves 32 of the adjustment sleeve 31 are designed so that the adjustment sleeve 31 is rotatable from a position shown in FIG. 1 (setting for minimal or no exciter force) to a position shown in FIG. 3 (setting for maximum exciter force) by precisely 90°. The unbalance weights may thus each pivot relative to one another in opposite directions by 90° for a total of 180°. An arbitrary continuous setting is possible between the settings for minimal and maximal exciter force.

The pivoting of the unbalance weights 12, 13 is usually performed in operation during the rotation of the main shaft 10. In the event of a fixedly set phase difference of the unbalance weights 12, 13, the unbalance weights 12 and 13, which are mounted so they are rotatable using roller bearings 14, 15, are driven with the pinions 41, 42 via the transmission medium 46, in this case via the gearing. The pinions are stationary. The connection via the gearing is thus to be viewed as a static connection. The set unbalance weights 12, 13 rotate in the same direction as the main shaft. A great advantage of the device according to the invention is clear in this case. Because of the implementation of the coupling 40 using crown wheels 43, 44 and pinions 41, 42, the mass inertias of the unbalance weights 12, 13 occurring during the rotation of the main shaft 10 are mutually supported via the pinions 41, 42, so that no undesired pivoting of the unbalance weights 12, 13 can occur. The coupling 40 including the transmission medium 46 promotes a type of self-locking. Furthermore, it follows that the transmission medium carrier 45 must only absorb minimal support forces and support torques because of the symmetrical engagement of the gearing parts in relation to the axis of symmetry of the transmission medium carrier 45, so that great advantages are achieved in regard to the service life and robustness of the coupling 40 according to the invention. In addition, the gearing can be implemented easily and cost-effectively as forge or cast gearing parts, for example.

The adjustment of the oscillation amplitude of the exciter force in operation using opposing pivoting of the unbalance weights 12, 13 is to be viewed as a superposition of the partial movements rotation of the unbalance weights 12, 13 at the speed of the unbalance shaft 10 and pivoting of the unbalance weights 12, 13 in opposite directions by a desired angle amount.

FIG. 3 shows the device 1 according to the invention in a position in which the exciter force is maximal, because the unbalance weights 12, 13 have equal angles relative to the main shaft 10.

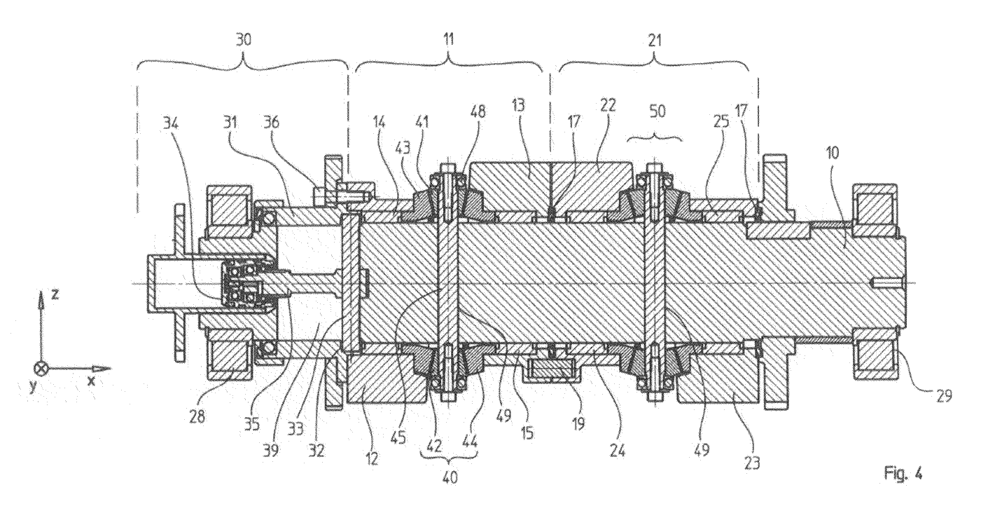

FIG. 4 shows a longitudinal section of the device 1 according to the invention. In this exemplary embodiment, two unbalance weight pairs 11, 21 having the unbalance weights 12, 13 and 22, 23 are situated so they are rotatable on the main shaft 10 via the bearings 14, 15, 24, 25. Each unbalance weight pair 11, 21 has a coupling 40 or 50, respectively. In addition, the adjacent unbalance weights 13, 22 of the unbalance weight pairs 11, 21 are connected in phase using a positive connection element 19. In this way, a series connection of the unbalance weight pairs 11, 21 is made possible, so that only a single adjustment unit 30 must be connected to only a single unbalance weight 12 in order to allow a simultaneous adjustment of all unbalance weights 12, 13, 22, 23 located on the unbalance shaft 10. All unbalance weights 12, 13, 22, 23 are expediently of equal size and equal weight. The couplings 40 and 50 are also identical.

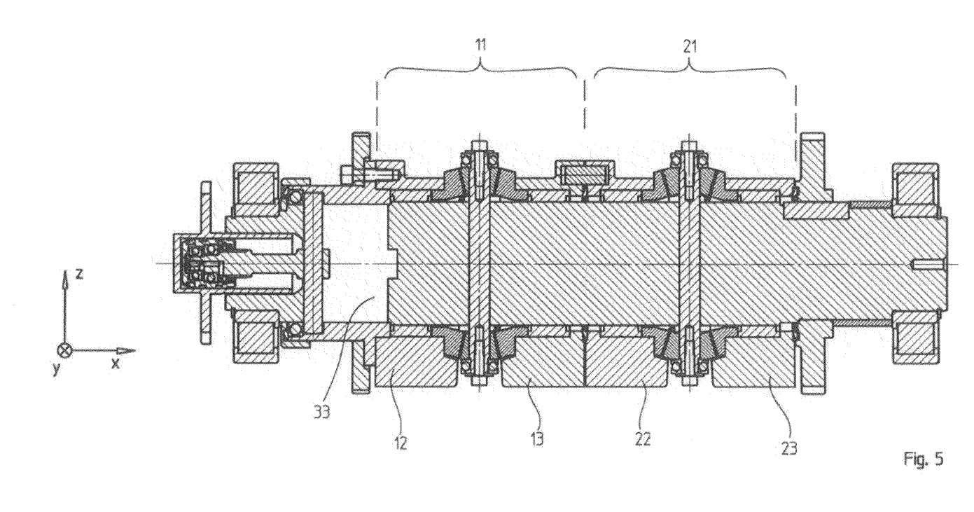

In order to reach the angles of the unbalance weights 12, 13, 22, 23 (maximum exciter force) shown in FIG. 5 from the angles of the unbalance weights 12, 13, 22, 23 (minimal or no exciter force) shown in FIG. 4, the adjustment sleeve 31 of the adjustment unit 30 is pivoted by 90°, as already described in connection with FIGS. 1 through 3. The coupling 40 causes a pivoting of the unbalance weights 12, 13 in opposite directions by 90° each, so that the relative pivoting of the unbalance weights 12, 13 is 180° in total. Together with the unbalance weight 13, the unbalance weight 22, which is in phase therewith and connected positively thereto, of the second unbalance weight pair 21 pivots by the same angle amount. The coupling 50 results in pivoting of the unbalance weight 23 in the opposite direction in comparison to the unbalance weights 22, 13. Overall, it may thus be stated that through the series connection of the unbalance weight pairs 11, 21, the inner unbalance weights 13, 22 are kept in phase and, upon adjustment in the opposing direction, rotate like the outer unbalance weights 12, 23, which are in turn kept in phase using the couplings 40, 50 and the connection element 19.

A great advantage with the configuration of an even number of unbalance weight pairs 11, 21 connected in series on one main shaft 10 is that the roller bearings 28, 29 of the unbalance shaft 10 are not strained by undesired tilting torques thanks to the approximately symmetrical layout of the unbalance shaft 10 in relation to the center of the unbalance shaft 10.

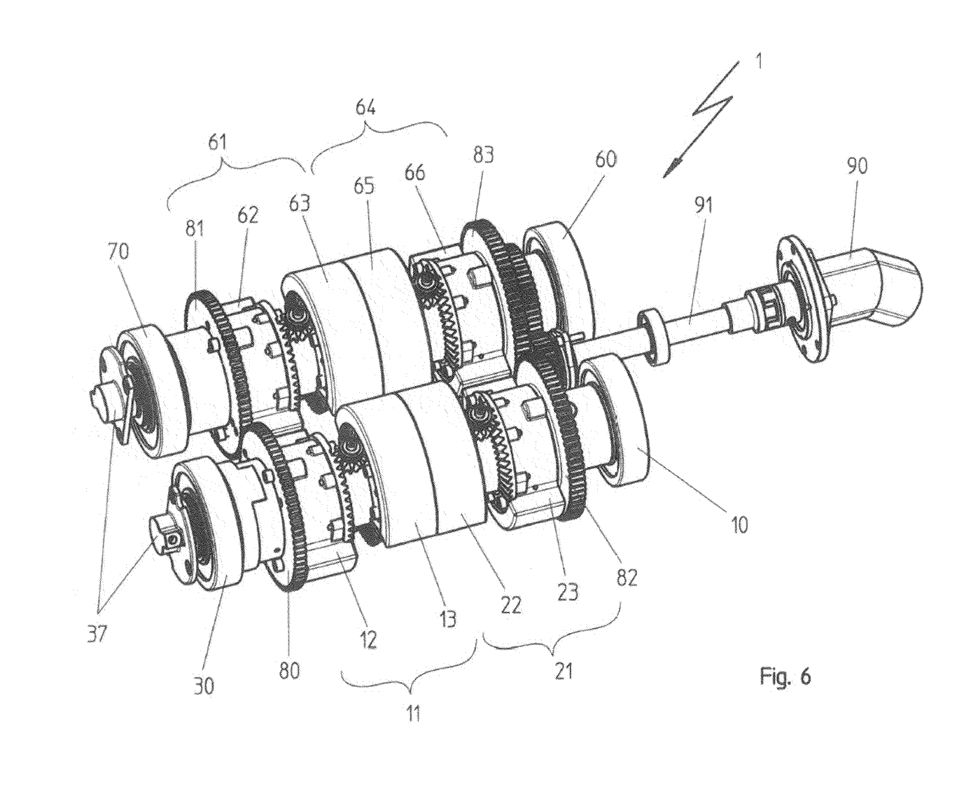

FIG. 6 shows a perspective overall view of an embodiment of the invention. A hydraulic drive 90 having the driveshaft 91 drives one of the two main shafts 10 or 60 via spur gears (not shown here) directly. The synchronization and rotational direction reversal occurs via the spur gear pair 82, 83, so that the unbalance shafts 10, 60 rotate at equal speed, but in opposite directions in operation. The main shafts 10, 60 have identical components. The modes of operation of both main shafts 10, 60 also correspond. The spur gear 80 is connected fixed via connection elements, such as screws/nuts, to the first unbalance weight 12 of the main shaft 10 and thus also to the adjustment sleeve 31 of the adjustment unit 30. The spur gear 81 is also connected to the unbalance weights 62 of the main shafts 60 and to the adjustment sleeve of the adjustment unit 70. The adjustment movement of the unbalance weights 12, 13, 22, 33 of the main shaft 10 may also be synchronized via the spur gear pair with the adjustment movement of the unbalance weights 62, 63, 65, 66 of the main shafts 60 and reversed in the rotational direction. The hydraulic activation units 37 of the adjustment units 30, 70 may thus be combined so that instead of the double-acting hydraulic cylinders, only single-acting hydraulic cylinders may be used. For example, if the adjustment pin 33 of the adjustment unit 30 is “pressed in” in the positive x direction (FIG. 4), via the opposing synchronization using the spur gears 80, 81, the adjustment pin (not shown here) of the adjustment unit 70 is correspondingly pressed-out in the negative x direction.

With the aid of the device according to the invention, the oscillation amplitude of the exciter force can easily and rapidly be adjusted continuously and during the rotation of the shaft through the pivoting of the unbalance weights from a minimal force, i.e., 0 kN, to a maximum force, such as 174 kN. It has proven to be particularly advantageous for the unbalance weights 12, 13, 22, 23 and 62, 63, 65, 66 to remain in the angles shown in FIG. 1, 4, or 6 in operation until reaching the rated speeds of the main shafts 10, 60. At these angles, no directional oscillation is generated. After reaching the rated speed, the unbalance weights may be pivoted until a desired absolute value of the oscillation amplitude of the exciter force is reached. A soft startup is thus made possible. Because the drive motor of the device 1 according to the invention, such as a diesel engine, can be operated constantly at the rated speed and only the adjustment of the exciter force exerts an influence on the motor operation, the drive motor can be operated efficiently and with optimized consumption. The startup behavior is thus better overall.

In the same way, upon shutdown or reversal of the machine having the device 1 according to the invention, the unbalance weights are first pivoted at rated speed into the zero position, so that no exciter forces are generated and subsequently the machine is shutdown or reversed. Undesired resonance ranges are avoided by the continuous operation of the device according to the invention at rated speed. Thus, no tumbling of the roller body occurs. If the device according to the invention is used for soil-compacting machines, for example, undesired cross grooves may be avoided, so that the quality of the compaction may be improved overall. The possibility of rapid and comfortable adaptation of the exciter force to the local conditions also contributes to the improvement. Because of the compactness, the device 1 according to the invention may be installed without problems even in already existing mass-produced machines. Through the adaptation of the compaction performance to the substrate, a noise reduction is achieved for both the surroundings and also the driver. Furthermore, the oscillation strain of the machine structure is significantly decreased.

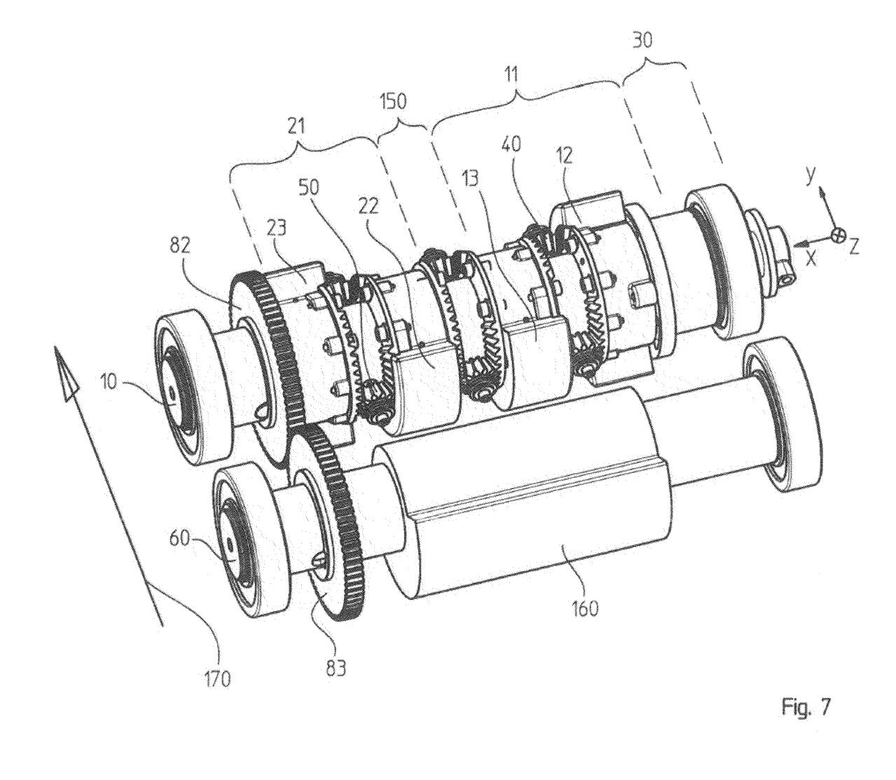

FIGS. 7 through 9 show a further preferred embodiment variant of the invention. In contrast to the examples shown in FIGS. 4 through 6, the two adjacent unbalance weights 13, 22 of the unbalance weight pairs 11 and 21 are not connected in phase and fixedly to one another, but rather are situated so they are pivotable to one another using an additional coupling 150, which essentially corresponds to the couplings 40, 50. Furthermore, the second main shaft 60 has an unbalance weight 160, which is situated rotationally fixed on the second main shaft 60. Through the connection of all adjacent unbalance weights 12, 13, 22, 23 using couplings 40, 150, 50, the machine which is equipped with the device 1 according to the invention is made drivable and steerable. Such machines may be vibration plates for soil compaction, for example.

FIG. 7 shows a setting of the unbalance weights 12, 13, 22, 23 for driving straight ahead in the indicated arrow direction 170. The unbalance weights 12, 23 assume an angle of +45° relative to the positive z axis in the y-z plane. The unbalance weights 13, 22 have an angle of −45° relative to the z axis. In the event of synchronous opposing rotation of the main shafts 10, 60 in the angles shown, in addition to the vertical component of the exciter force, a horizontal component is generated, whereby the device moves straight ahead in the running direction shown, namely in the positive y axis. The absolute value of the horizontal component is adjustable in a range, so that the travel velocity can be adapted optimally. If the device is used for a vibration plate, a separate drive for the forward or reverse movement of the vibration plate is thus not necessary.

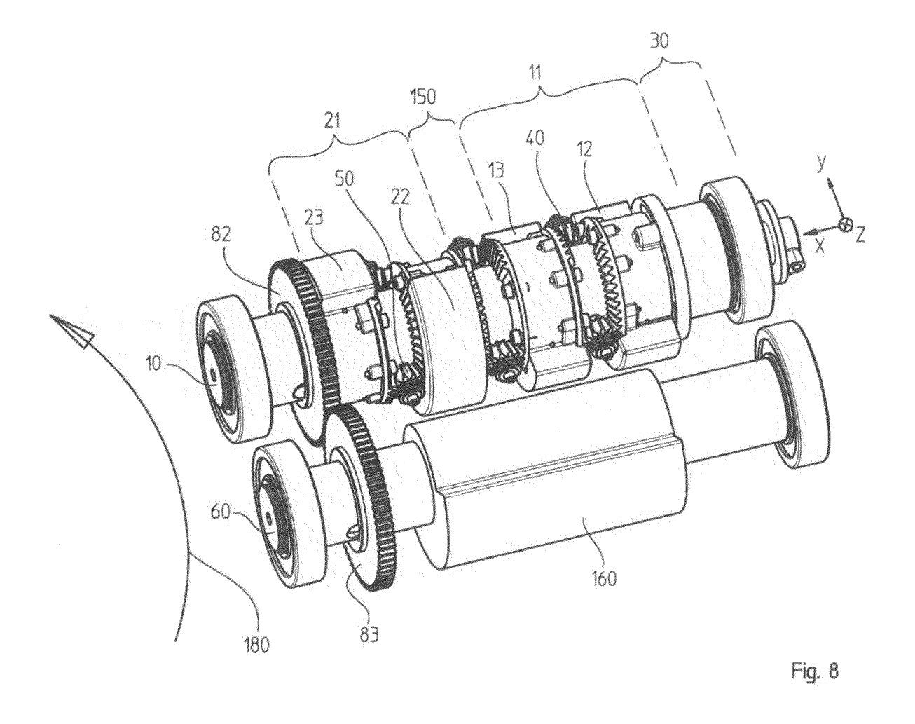

FIG. 8 shows a setting of the unbalance weights 12, 13, 22, 23 for turning to the left in the indicated arrow direction 180. For this purpose, the first unbalance weight 12 is rotated via the known adjustment unit 30, which is connected fixed to the unbalance weight 12, starting from the angles shown in FIG. 7 by −45° relative to the positive z axis, so that the unbalance force of the unbalance weight 12 points parallel to the z axis in the direction of the positive z axis. The coupling 40 causes a pivot of the unbalance weight 13 in the opposite direction in relation to the unbalance weight 12, so that the unbalance weights 12, 13 are in phase. The couplings 150, 50 each result in the pivoting in opposite directions of the adjacent unbalance weights 13, 22 and 22, 23, respectively, so that the unbalance weights assume the angles shown in FIG. 8. The force vectors of the left unbalance weight pair 21 having the unbalance weights 22, 23 point in the opposite direction, so that they cancel out. The force vectors of the right unbalance weight pair 11 having the unbalance weights 12, 13, in contrast, point in the same direction, so that they are added together. In operation, a resulting exciter force is formed, whereby in addition to the directional oscillation in the direction of the vertical z axis, a horizontal component is also generated, which allows a turn to the left, i.e., in the direction of the positive x axis.

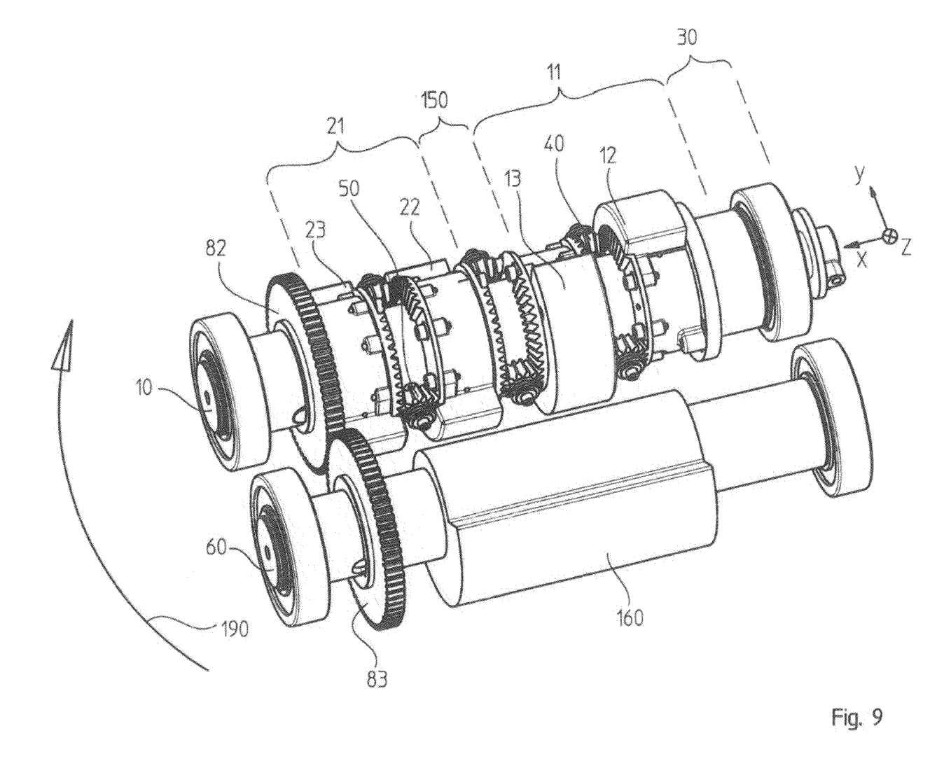

FIG. 9 shows a setting for the unbalance weights 12, 13, 22, 23 for turning to the right in the indicated arrow direction 190. For this purpose, the first unbalance weight 12 is rotated via the known adjustment unit 30, which is connected fixed to the unbalance weight 12, starting from the angle shown in FIG. 7 by +45° relative to the positive z axis, so that the unbalance force of the unbalance weight 12 points parallel to the y axis in the direction of the positive y axis. Because of the coupling 40, this results in an opposing pivot of the unbalance weight 13 by −45°. The unbalance weight 22 is rotated by +45° because of the coupling 150, i.e., in the same rotational direction as the unbalance weight 12. The coupling 50 results in a pivoting of the unbalance weight 23 by −45°. In comparison to the setting shown in FIG. 8, the force vectors of the left unbalance weight pair 21 having the unbalance weights 22, 23 are in the same direction and the force vectors of the right unbalance weight pair 11 having the unbalance weights 12, 13 are in opposite directions. In this way, turning to the right, i.e., in the direction of the negative x axis, is made possible in operation.

With the aid of the example according to the invention shown in FIGS. 7 through 9, a drivable and steerable machine, in particular a vibration plate for soil compaction, can be implemented in a simple and compact way, the travel velocity and the amplitude of the exciter force being able to be adapted optimally as needed.

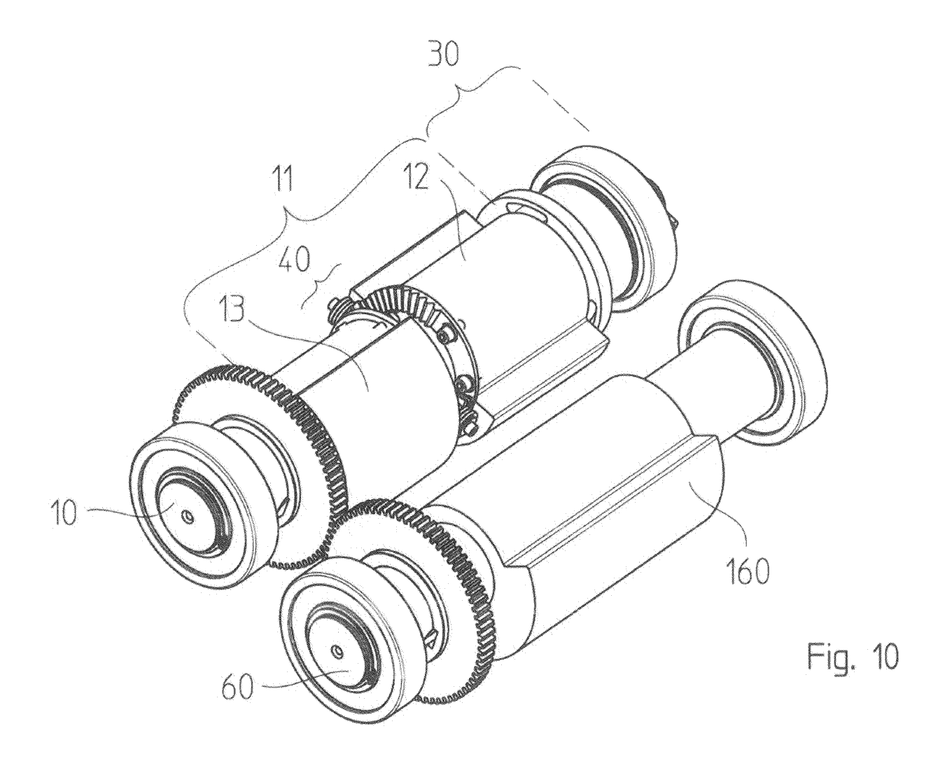

FIG. 10 shows a particularly compact and simple embodiment variant of the device according to the invention. The first main shaft 10 comprises only one unbalance weight pair 11 having the rotatably mounted unbalance weights 12, 13 and a coupling 40 situated between the unbalance weights 12, 13 and an adjustment unit 30, which is connected to the first unbalance weight 12. A second main shaft 60 is positively coupled to the first main shaft 10, the second unbalance shaft having an unbalance weight 160 situated rotationally fixed thereon. The adjustment of the angles of the unbalance weights 12, 13 is performed in the way according to the invention described up to this point. Through this configuration of the unbalance weights, in operation, i.e., during the synchronous rotation in opposite directions of the main shafts 10, 60, a controllable tumbling can be set as a result of the occurring tilting torque when the unbalance weights are not in phase. The machine, such as a vibration plate, can thus execute a turn to the right or left. After completed turning, the operation can then be changed back to normal operation again easily and comfortably.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A device, in particular a circular exciter, for generating a variable, rotating exciter force using a rotating main shaft, the main shaft having unbalance weights and a coupling between the unbalance weights and the oscillation amplitude of the exciter force being adjustable continuously in operation using an adjustment unit via the relative rotation of the unbalance weights toward or away from one another between a minimum value and a maximum value, wherein the unbalance weights are mounted on the main shaft and rotatable thereon, and the coupling comprises a transmission medium connected, and rotationally fixed, to the main shaft, which acts as a driver on the unbalance weights and causes an adjustment of the oscillation amplitude of the exciter force through the pivoting of the unbalance weights in opposite directions.

2. A device for generating a directional oscillation including a first and a second main shaft, which are situated in parallel and synchronously rotate in opposite directions, each main shaft having unbalance weights and a coupling between the unbalance weights, wherein the oscillation amplitude of the exciter force is continuously adjustable in operation between a minimum value and a maximum value using an adjustment unit via the relative rotation of the unbalance weights toward or away from one another, wherein the unbalance weights are mounted on the main shaft and rotatable thereon, and the coupling comprises a transmission medium connected, and rotationally fixed, to the main shaft, which acts as a driver on the unbalance weights and causes an adjustment of the oscillation amplitude of the exciter force by the pivoting of the unbalance weights in opposite directions.

3. The device according to claim 1, wherein the coupling comprises bevel gears including at least one pinion and two crown gears, wherein each unbalance weight has one crown gear and the transmission medium includes said at least one pinion, which is engaged with the two crown gears.

4. The device according to claim 1, wherein the coupling has multiple transmission media, each offset by an angle.

5. The device according to claim 1, wherein the transmission medium is rotatable on a transmission medium carrier and has a rotational axis which perpendicularly intersects the rotational axis of the main shaft.

6. The device according to claim 5, wherein the main shaft has at least one transverse hole for receiving the transmission medium carrier.

7. The device according to claim 5, further comprising means for absorbing centrifugal forces generated by the transmission medium situated on the transmission medium carrier.

8. The device according to claim 5, wherein the transmission media are mounted, floating, on the transmission medium carrier.

9. The device according to claim 1, wherein one of the unbalance weights is connected to the adjustment unit.

10. The device according to claim 1, wherein the main shaft has a number of unbalance weight pairs having equally large unbalance weights, each unbalance weight pair comprising a coupling situated therebetween.

11. The device according to claim 10, wherein the unbalance weights are connected in series such that adjacent unbalance weights of the unbalance weight pairs are connected in phase to one another.

12. The device according to claim 1, wherein the unbalance weights include means for axial play reduction.

13. The device according to claim 10, wherein the main shaft has an even number of the unbalance weight pairs, which are connected in series.

14. The device according to claim 1, wherein the unbalance weight pairs are connected to one another via a further coupling.

15. The device according to claim 1, wherein the second main shaft has an unbalance weight connected, and rotationally fixed, thereto.

16. A use of a device for generating a directional oscillation according to claim 15 for a vibration plate for soil compaction, wherein the vibration plate is drivable and steerable.

17. The device according to claim 1, wherein the coupling includes multiple transmission media, each offset by an equal angle.

18. The device according to claim 7, wherein the means for absorbing centrifugal forces is axial bearings.

19. The device according to claim 10, wherein the unbalance weights are connected in series such that adjacent unbalance weights of the unbalance weight pairs are connected positively in phase to one another.

20. The device according to claim 1, wherein the means for axial play reduction is spring elements.
